(19) United States
(12) Patent Application Publication
(10) Pub. No.: US 2022/0165444 A1
(43) Pub. Date: May 26, 2022

(54) HIGH-DENSITY SUBTERRANEAN STORAGE SYSTEM FOR NUCLEAR FUEL AND RADIOACTIVE WASTE

(71) Applicant: HOLTEC INTERNATIONAL, Camden, NJ (US)

(72) Inventor: Krishna P. SINGH, Jupiter, FL (US)

(73) Assignee: HOLTEC INTERNATIONAL, Camden, NJ (US)

(21) Appl. No.: 17/527,476

(22) Filed: Nov. 16, 2021

Related U.S. Application Data
(60) Provisional application No. 63/118,350, filed on Nov. 25, 2020.
(60) Provisional application No. 63/123,706, filed on Dec. 10, 2020.

(51) Int. Cl. G21F 7/015; G21F 5/008; G21F 5/10; G21F 9/34

(52) U.S. Cl. CPC G21F 7/015; G21F 9/34; G21F 5/10; G21F 5/008

(57) ABSTRACT

An underground passively ventilated nuclear waste storage system includes an array of cavity enclosure containers each including a cavity holding a nuclear waste canister containing radioactive waste generating heat. Each container comprises at least one pair of air inlets each fluidly coupled directly to separate vertical cooling air feeder shells spaced apart from the container. The feeder shell in fluid communication with ambient air operates to draw in ventilation air which flows to the container via natural convective thermo-siphon effect driven by heat emitted from the canister which heats the container cavity. The containers are arranged in a serial spaced apart manner in multiple parallel rows. The containers within each row are fluidly isolated from containers in other rows. Containers within each row are further fluidly isolated from other containers therein when the ventilation system operates. The containers may be part of a consolidated interim storage facility for radioactive waste.

### CROSS-REFERENCE TO RELATED APPLICATIONS

The present application claims the benefit of U.S. Provisional Patent Application No. 63/118,350 filed Nov. 25, 2020, and U.S. Provisional Patent Application No. 63/123,706 filed Dec. 10, 2020; which are incorporated herein by reference in their entireties.

### FIELD OF THE INVENTION

The present invention relates to spent nuclear fuel and radioactive waste storage systems, and more particularly to such a system suitable for consolidated interim waste storage.

### BACKGROUND OF THE INVENTION

Used or spent nuclear fuel and radioactive waste materials are presently stored on an interim basis “on site” at commissioned and some decommissioned nuclear generating plants until the federal government provides a central permanent repository. For example, spent nuclear fuel (SNF) is stored in the reactor fuel pool after removal from the core where it continues to generate decay heat. The fuel can be transferred after a period of cooling in the pool to nuclear waste canisters which are placed in thick-walled outer vessels such as dry storage modules or casks typically constructed of concrete, steel, and iron, etc. to provide containment and radiation shielding. The casks are stored on site at the generating plant.

The concept of using consolidated interim storage (CIS) is intended to provide geographically distributed off-site storage facilities for spent nuclear fuel and other high level nuclear radioactive wastes gathered from a number of individual generating plant sites, thereby providing greater control over the widely dispersed waste stockpiles. The waste materials are stored in sealed nuclear waste canisters such as a multi-purpose canister (MPC) available from Holtec International Inc. of Camden, N.J. The canister generally includes an elongated cylindrical stainless steel shell, baseplate, and lid hermetically seal welded to the shell to form the confinement boundary for the stored fuel assemblies disposed in the canister. A fuel basket arranged inside the canister has a rectilinear honeycomb construction defining a plurality of open prismatic cells which each hold a nuclear fuel assembly. The fuel assembly comprises a plurality of nuclear fuel rods or “cladding” which contains the uranium fuel pellets that continue to emit considerable decay heat after removal from the nuclear reactor.

The nuclear waste canisters may be initially transported to the CIS facility from the generating plants for a period of time, with the eventual goal of a final move to a permanent nuclear waste repository when available from the government. Such so called independent spent fuel storage installations (ISFSI) are facilities designed for the interim storage of spent nuclear fuel comprising solid, reactor-related, greater than Class C waste, in addition to other related radioactive materials. Each ISFSI facility would typically maintain an inventory of a multitude of waste canisters containing spent nuclear fuel and/or radioactive waste materials.

Some ISFSIs comprise multiple storage modules which store nuclear waste below ground/grade and are ventilated by natural ambient cooling air. Such existing underground nuclear waste storage systems however do not meet all current needs of ISFSIs in all situations. For example, the modules may be fluidly coupled to the source of available ambient cooling air and/or each other in a manner which may deprive certain modules of the ventilation air required for optimal cooling of the radioactive waste in each module.

Improvements in such underground ventilated nuclear waste storage systems are desired.

### SUMMARY OF THE INVENTION

The present disclosure in one aspect provides an underground naturally ventilated and passively cooled radioactive nuclear waste storage system designed for below ground/grade storage of fuel. The system comprises a plurality of modules such as CECs (cavity enclosure containers) which may be arrayed in an upright position on a subterranean concrete base pad situated below the storage site's final cleared grade of topsoil and/or engineered fill. A majority of the height of the underground CECs is therefore preferably located below grade created a low profile for protection against potential intentional or unintentional projectile impacts. The CECs in the array may be arranged in a single-file linear pattern spaced apart manner thereby forming nuclear waste storage row extending horizontally along a common longitudinal axis in in one embodiment. Multiple parallel linear rows of CECs may be provided in a CIS facility which may form an ISFSI facility.

In one embodiment, each CEC defines an internal cavity diametrically configured in cross-sectional area for holding a single cylindrical spent nuclear fuel (SNF) canister. The canister holds the SNF assemblies and/or other high level radioactive waste materials as previously described herein which continue to emit considerable amounts of heat that require dissipation in order to protect the structural integrity of fuel assemblies or other waste material. In certain other embodiments contemplated, multiple canisters may be vertically stacked one above each other in a single CEC such as disclosed in commonly owned U.S. Pat. No. 9,852,822, which is incorporated herein by reference. In this case, the CECs may be diametrically configured in cross-sectional area to hold a single canister at a single elevation in both the upper and lower positions within the CEC.

The CECs and canisters inside are cooled using a passive ambient air ventilation system unassisted by fans or blowers in preferred but non-limiting embodiments to circulate cooling air through the CECs. Heat emitted by the canister fluidly drives a convective natural thermo-siphon effect to draw ambient air through the CECs cavity in the annulus between the CEC and canister as the air inside the annulus is heated by the canister. In other possible embodiments, fans/blowers may be provided if necessary, but are less preferred since the interruption of electrical power to the CIS site may interfere with the ability to adequately cool the CECs and radioactive nuclear fuel and/or other waste material housed therein.

In preferred but non-limiting embodiments, each CEC includes a minimum of two air inlets. Two air inlets are provided in one embodiment. The air inlets are fluidly coupled via laterally and horizontally extending flow conduits directly to at least one direct source of cooling air (i.e. there are no intervening CECs in the air flow pathway defined by the flow conduits between the cooling air source and air inlets of the CEC). Further, each CEC is not fluidly coupled in a direct manner via the flow conduits to any other CEC (i.e. shell-to-shell). This advantageously minimizes fluidic air flow interaction between adjacent CECs which may result in air pressure imbalance in which those CECs containing radioactive waste materials emitting greater heat than others disproportionally draw a greater amount of the available ventilation air in the system than other CECs which may be partially starved of sufficient cooling air.

The cooling air source in some implementations may be one or more vertically-elongated and tubular/hollow ambient cooling air feeder shells. The air feeder shells may have a smaller outer diameter than the CECs, thereby allowing the CECs to be spaced as closely as possible to conserve available nuclear waste storage space at the CIS facility within each row of CECs. The air feeder shells are each in fluid communication with ambient atmosphere at top and operable to draw cooling air downwards into the shell via the natural convective thermo-siphon effect driven by the heat emitted from nuclear waste canister within the CEC. The air flows to and enters the CEC via the flow conduits, is heated by the radioactive waste in the canister, and then is exhausted back to atmosphere through the top of the CEC which may be located above grade to define an air outlet.

In some embodiments disclosed herein, the pair of air inlets of the CEC may each be fluidly coupled directly to a single discrete and separate cooling air feeder shell via the flow conduits. In other embodiments disclosed herein, the CEC is fluidly coupled directly to a pair of air feeder shells via flow conduits. In yet other embodiments disclosed herein for nuclear waste still emitting extremely high levels of heat conductively passed through the nuclear waste canister walls, a high airflow capacity system is provided in which each CEC is fluidly coupled to two pairs (i.e. four) cooling air feeder shells. In all of these embodiments, each air inlet of the CEC is fluidly coupled directly to an air feeder shell via a separate dedicated single flow conduit rather than a shared branch or header type flow conduit arrangement as in some past approaches which may prevent each CEC from receiving the required volume/flow rate of cooling air in some situations.

In any of the foregoing three possible cooling air supply arrangements of the CECs and cooling air feeder shells, the provision of at least two separate air inlets for each CEC and direct fluid coupling to one or more feeder shells advantageously improves the ability of the natural ventilation system to adequately cool each CEC to the necessary degree in order to protect the structural integrity of the SNF assemblies and/or other high level nuclear waste stored inside the canisters in the CEC. Because the ambient cooling air flowing to each CEC from one or two cooling air feeder shells does not first pass through any upstream intervening CECs such as employed in some prior systems, the flow rate of ambient cooling air supplied directly to the CEC for naturally ventilating its interior space or cavity and cooling the SNF canister is therefore not diminished. This prevents the situation in such prior ventilation systems where a vertically-oriented CEC or storage shell located at the end of a number of fluidly and serially interconnected CECs may not receive an adequate amount of cooling air due. This is due to the fact that upstream CECs may have drawn a disproportionate share of the available cooling air supply flowing through the ventilation system. By instead directly coupling each CEC directly to at least one cooling air feeder shell according to the present disclosure, the required amount of cooling air to adequately cool the canister in each CEC via the thermo-siphon fluid flow effect is assured irrespective of the level of decay heat generated by the radioactive waste material in each CEC. Air pressure imbalances between the CECs due to disparate levels of decay heat are thus also avoided.

In a nuclear waste storage system such as a CIS facility with passive ambient air ventilation system according to the present disclosure in which multiple parallel linear rows of CECs are provided, no CEC in one row may be fluidly coupled to any other CECs or cooling air feeder shells in another adjacent row either directly or indirectly (i.e. via an intervening CEC or flow conduits). This prevents fluidic interaction between CECs in adjoining rows which could result in possible pressure and flow imbalances, thereby causing disproportionate cooling of some CECs versus others as previously described herein. In addition, it bears noting that use of multiple parallel rows of CECs which are not fluidly interconnected advantageously simplifies expansion of an existing CIS facility since no prior rows of CECs need to be partially unearthed to make new fluid couplings to existing buried CECs.

The collective array of CECs according to the present disclosure may form part of an independent spent fuel storage installation (ISFSI) facility suitable for a CIS system that may include any suitable number of CECs desired. The CECs may be part of a CIS system such as HI-STORM UMAX (Holtec International Storage Module Underground Maximum Safety) which is an underground Vertical Ventilated Module (VVM) dry spent fuel storage system engineered to be fully compatible with all presently certified multi-purpose canisters (MPCs). Each HI-STORM UMAX Vertical Ventilated Module provides storage of an MPC in the vertical configuration inside a cylindrical cavity located entirely below the top-of-grade of the ISFSI. The VVM, akin to the aboveground overpack, is comprised of the CECs; each of which includes a removable top closure lid according to the present disclosure.

The nuclear waste canisters usable in the present CECs, which may contain both radioactive used or spent nuclear fuel (SNF) and/or non-fuel radioactive waste materials, may be stainless steel multi-purpose canisters (MPCs) available from Holtec International of Camden, N.J. Other canisters may be used.

The present underground nuclear waste storage system is intended to provide vanishingly low site boundary radiation dose levels and safety during catastrophic events. As an underground system, the system takes advantage of the surrounding soil/engineered fill or subgrade to provide radiation shielding, physical protection, and a low center of gravity for a stable storage installation.

According to one aspect, an underground passively ventilated nuclear waste storage system comprises: a horizontal longitudinal axis; a subterranean concrete base pad; a vertically elongated first cavity enclosure container located on the base pad and the longitudinal axis, the cavity enclosure container defining a vertical centerline axis and comprising a first air inlet, a second air inlet, an air outlet, and an internal cavity; the cavity of the first cavity enclosure container being configured for holding a nuclear waste canister which contains radioactive nuclear waste emitting heat; a vertically elongated first cooling air feeder shell in fluid communication with an ambient atmosphere and operable to draw in ambient air, the first cooling air feeder shell being fluidly coupled directly to the first air inlet of the first cavity enclosure container via a first flow conduit; a vertically elongated second cooling air feeder shell in fluid communication with the ambient atmosphere and operable to draw in ambient air, the second cooling air feeder shell being fluidly coupled directly to the second air inlet of the first cavity enclosure container via a second flow conduit. In one embodiment, the first cavity enclosure container is not fluidly coupled directly to any other cavity enclosure container.

According to another aspect, an underground passively ventilated nuclear waste storage system comprises: a horizontal longitudinal axis; a subterranean concrete base pad; a vertically elongated first cavity enclosure container located on the base pad and the longitudinal axis; a vertically elongated second cavity enclosure container located on the base pad and the longitudinal axis, the second cavity enclosure container being spaced apart from the first cavity enclosure container; the first and second cavity enclosure containers each defining a vertical centerline axis and comprising a first air inlet, a second air inlet, an air outlet, and an internal cavity; a nuclear waste canister positioned in each of the internal cavities of the first and second cavity enclosure containers, the canister emitting heat; a vertically elongated cooling air feeder shell arranged on the longitudinal axis between the first and second cavity enclosure containers, the cooling air feeder shell being in fluid communication with an ambient atmosphere and operable to draw in ambient air; the cooling air feeder shell fluidly coupled directly to the first air inlet of the first cavity enclosure container via a first flow conduit; the cooling air feeder shell fluidly coupled directly to the first air inlet of the second cavity enclosure container via a second flow conduit; wherein the first cavity enclosure container is not fluidly coupled directly to any other cavity enclosure container, and the second cavity enclosure container is not fluidly coupled directly to any other cavity enclosure container.

According to another aspect, a consolidated interim storage facility for nuclear waste comprises: a plurality of elongated cavity enclosure containers each founded on a subterranean base pad and extending vertically upwards therefrom to a concrete top pad; an engineered fill disposed between the base and top pads; the cavity enclosure containers being arranged in an array comprising a plurality of longitudinally-extending and parallel linear rows of cavity enclosure containers, each row defining a longitudinal axis and the cavity enclosure containers each being arranged on the longitudinal axis; a plurality of vertically elongated cooling air feeder shells disposed in each row on the respective longitudinal axis, one cooling air feeder shell being interposed between and fluidly coupled directly to a pair of the cavity enclosure containers on opposite sides of the cooling air feeder shell, the cooling air feeder shells each being in fluid communication with an ambient atmosphere; the one cooling air feeder shell being operable to draw in ambient air and distribute the air to directly to each pair of cavity enclosure containers; wherein the cavity enclosure containers in each row are fluidly isolated from the cavity enclosure containers in any other row.

According to another aspect, an underground passively ventilated nuclear waste storage apparatus for a consolidated interim storage facility, the apparatus comprising: a vertically elongated cavity enclosure container supported on a subterranean base pad and extending vertically upwards therefrom to a concrete top pad; an engineered fill disposed between the base and top pads; a nuclear waste canister positioned in an internal cavity of the cavity enclosure containers, the canister emitting decay heat which heats air in an annulus formed between the cavity enclosure container and the canister; a vertically elongated hollow cooling air feeder shell arranged on a lateral side of the cavity enclosure container, the cooling air feeder shell being in fluid communication with an ambient atmosphere and operable to draw in ambient air; the cooling air feeder shell fluidly coupled directly to a lower portion of the cavity by a first air inlet of the cavity enclosure container via a first flow conduit; the cooling air intake shell further fluidly coupled directly to the lower portion of the cavity by a second air inlet of the cavity enclosure container via a second flow conduit; the first and second flow conduits being fluidly coupled to a lower portion of the cooling air feeder shell; wherein a cooling air flow pathway is defined in which ambient cooling air is drawn into the cooling air feeder shell, flows through the first and second flow conduits to the lower portion of the cavity of the cavity enclosure container, flows upwards in the annulus and is heated by the canister, and exits from an air outlet at a top of the cavity enclosure container back to atmosphere.

### BRIEF DESCRIPTION OF THE DRAWINGS

The features of the exemplary embodiments of the present invention will be described with reference to the following drawings, where like elements are labeled similarly, and in which:

FIG. 1 is a perspective view of an ISFSI facility comprising a first embodiment of a nuclear waste storage system according to the present disclosure for consolidated interim storage of spent nuclear fuel and other high level radioactive nuclear waste materials;

FIG. 2 is a top plan view thereof;

FIG. 3 is a perspective view of one of the nuclear waste storage rows of the ISFSI facility of FIGS. 1 and 2;

FIG. 4 is a first cross sectional view of a second embodiment of a nuclear waste storage system showing a cavity enclosure container (CEC) and cooling air feeder shell thereof;

FIG. 5 is a second cross sectional view thereof of the CEC alone;

FIG. 6 is a top plan view of an arrangement of multiple CECs of the second embodiment;

FIG. 7 is a perspective view of one nuclear waste storage row according to the second embodiment;

FIG. 8 is a top perspective view of the first embodiment of a nuclear waste storage system of FIGS. 1-3 showing one of the modular nuclear waste storage units including a CEC; pair of directly fluidly coupled cooling air feeder shells all mounted on a common support plate;

FIG. 9 is a bottom perspective view thereof;

FIG. 10 is a first lateral side view thereof;

FIG. 11 is a second lateral side view thereof;

FIG. 12 is a front view thereof;

FIG. 13 is a top view thereof with the top lid in place on the CEC;

FIG. 14 is a top view thereof with the top lid removed to show the internal cavity of the CEC;

FIG. 15 is a top view thereof with the top air intake housing removed from the pair of cooling air feeder shells to reveal the array of radiation attenuator plates therein;

FIG. 16 is a top perspective view thereof;

FIG. 17 is a cross-sectional perspective view thereof showing the modular nuclear waste storage unit installed on a concrete base pad below grade, a concrete top pad, and engineered fill therebetween;

FIG. 18 is a cross-sectional side view thereof;

FIG. 19 is a cross-sectional side view thereof showing multiple CECs and cooling air feeder shells; in part of the nuclear waste storage row of FIG. 3;

FIG. 20 is a top view of a third embodiment of a nuclear waste storage system according to the present disclosure showing a pair of CECs and cooling air feeder shells.

All drawings are schematic and not necessarily to scale. Parts given a reference numerical designation in one figure may be considered to be the same parts where they appear in other figures without a numerical designation for brevity unless specifically labeled with a different part number and described herein. References herein to a whole figure number herein which may comprise multiple figures with the same whole number but different alphabetical suffixes shall be construed to be a general reference to all those figures sharing the same whole number, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

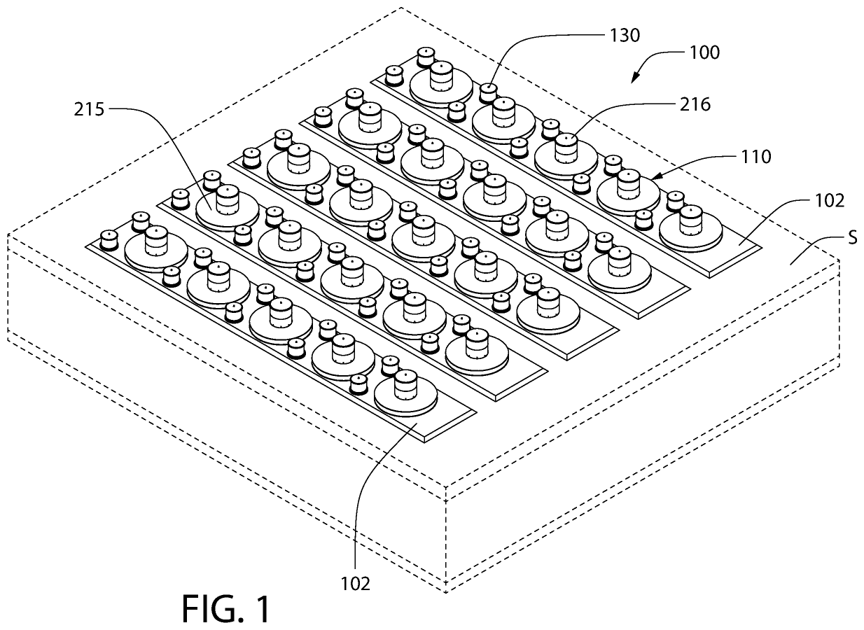

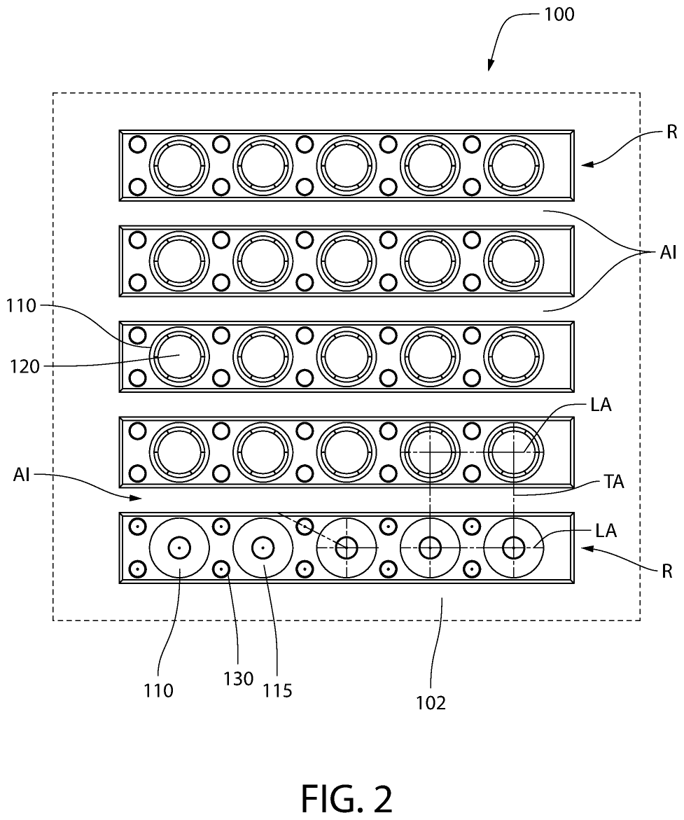

FIGS. 1 and 2 depict a top views of an ISFSI facility comprising a passively cooled subterranean consolidated interim storage (CIS) system 100 according to the present disclosure. System 100 comprises an array of underground vertical ventilated cavity enclosure containers (CECs) 110 each holding a single nuclear waste canister 150 containing the radioactive nuclear waste, and vertically elongated cooling air feeder shells 130 interspersed between and fluidly coupled to the CECs according to the present disclosure. The CECs and air feeder shells are configured to form integral parts of an unpowered natural convective ventilation system which operates via the thermo-siphon effect to cool the nuclear waste fuel stored in each CEC, as further described herein.

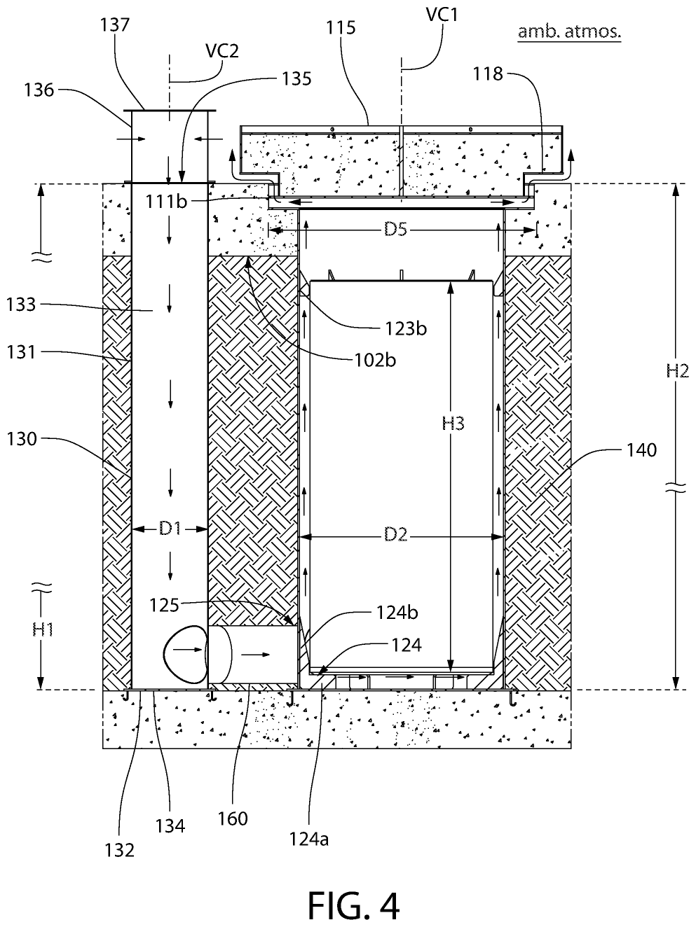

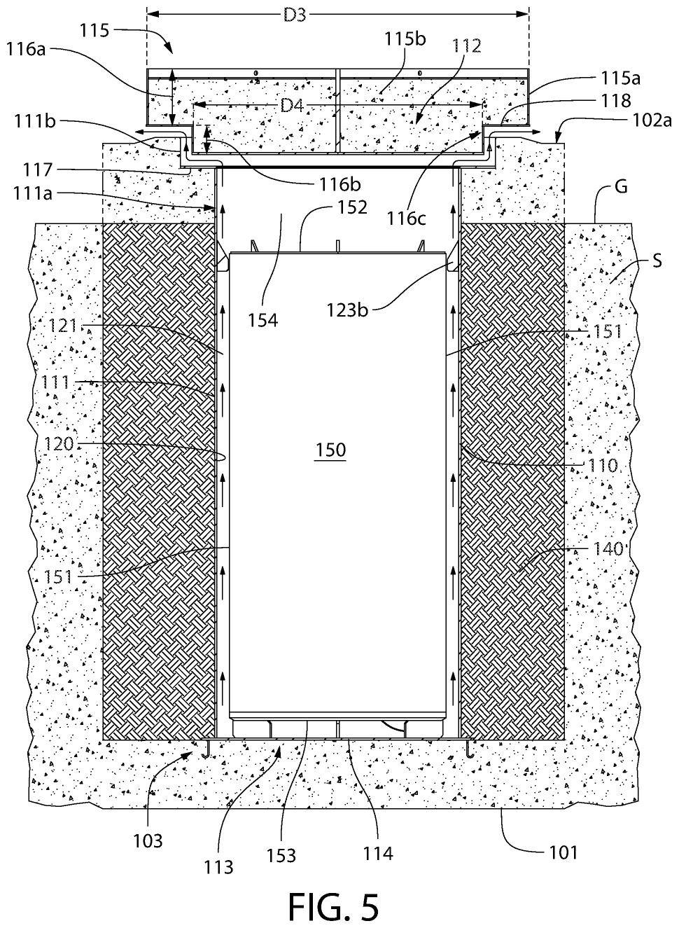

FIGS. 4 and 5 depict one embodiment of a CEC 110 and cooling air feeder shell 110 of a nuclear waste storage system according to the present disclosure in greater detail. The CECs 110 and cooling air feeder shells 130 are founded on and supported by a thick and horizontally extending subterranean bottom base pad 101 located below a cleared top surface or grade “G” of the native soil “S” at the CIS system site. Base pad 101 may be made of reinforced concrete in one embodiment; however, in other embodiments other materials may be used such as compacted gravel so long a stable and firm base is provided to support the CECs and air feeder shells. In the case of concrete as shown in the illustrated embodiment, the CECs and air feeder shells may be rigidly anchored to the base pad via multiple anchor members 103 such as robust J-shaped fasteners (threaded or otherwise), or other suitable types of anchors commonly used for fastening structural objects to concrete. Preferably, base pad 101 has a suitable thickness and construction robust enough to withstand postulated seismic events and maintain safe support the CECs 110 and containment of their nuclear waste contents.

A horizontally and longitudinally extending concrete top pad 102 is formed on top of the engineered fill 140 described below which is placed after pouring base pad 101. Top pad 102 therefore protrudes upwards from and is raised above the cleared grade G of the surrounding native soil S. The top pad is vertically spaced apart from the below grade base pad 101. The top pad defines an upward facing top surface 102a elevated above grade to prevent the ingress of standing water from the surrounding native soil S into the CECs 110 originating from rain events. Top surface 102a is substantially parallel to an upward facing top surface 101a of base pad 101 (the term “substantially” accounting for small variations in the level of surfaces 101a, 102a and recesses and/or contours formed therein for various purposes). The top pad 102 preferably extends at least one CEC outer diameter beyond the peripheral CECs 110. A gradually sloping terrain of native soil S around the top pad is preferred to facilitate rainwater drainage away from the CECs.

The vertical gap or space formed between base and top pads 101, 102 including the open horizontal/lateral space between adjacent CECs 110 and cooling air feeder shells 130 is filled with a suitable “engineered fill” 104 to provide both lateral radiation shielding for the nuclear waste stored inside the CECs 110, and full lateral structural support to the CECs and the cooling air feeder shells 130. Any suitable engineered fill may be used, such as without limitation flowable CLSM (controlled low-strength material) which is a self-compacting cementitious fill material often used in the industry as a backfill in lieu of ordinary compacted soil fill. Plain concrete may also be used as the inter-CEC and base pad to top pad gap filler material if it is desired to further increase the CIS system's radiation dose blockage capabilities. Other types of fill material which can provide radiation shielding and lateral support of the CECs and air feeder shells may be used.

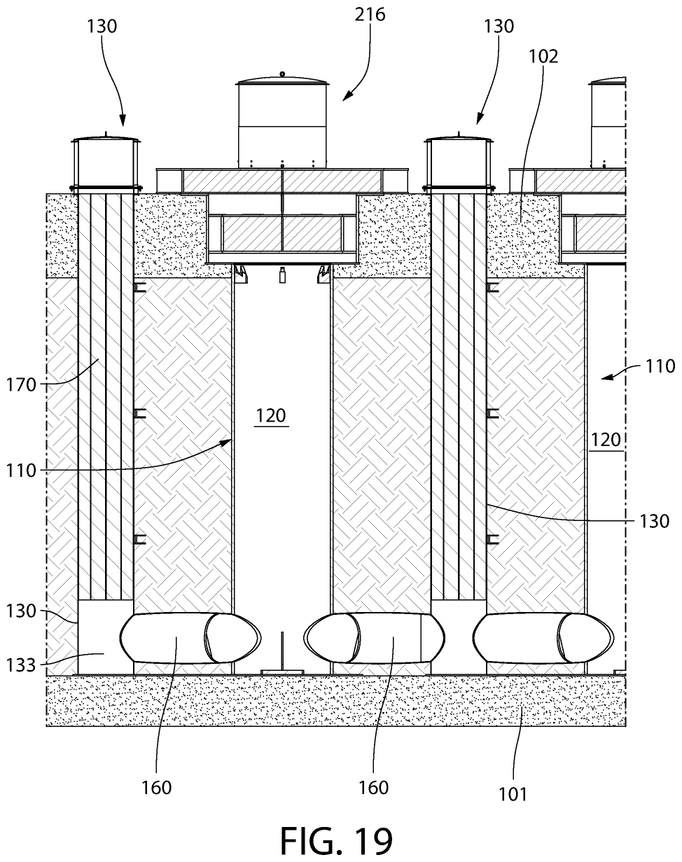

With continuing general reference to FIGS. 4 and 5, each CEC 110 comprises a vertically elongated metallic shell body 111 defining a vertical centerline axis VC1 and which extends between a top end 112 and bottom end 113 of the body. The upper portion 111a of the shell body which defines top end 112 may be embedded in in concrete top pad 102 including between the top surface 102a and bottom surface 102b of the top pad 102 as shown. In some embodiments shown in FIGS. 4-5 and 17-19. the top end 112 of the CEC shell body 111 may terminate at the top surface 102a of the top pad. In either case, body 111 of CEC 110 may be cylindrical with a circular transverse cross-sectional shape in preferred non-limiting embodiments; however, other non-polygonal and polygonal shaped bodies may be used in certain other acceptable embodiments. The shell body 111 of each CEC 110 defines a vertically extending internal cavity 120 extending between ends 112, 113 which is configured for holding a cylindrical nuclear waste canister 150. As previously described herein, the waste canister 150 defines an interior space which holds spent fuel assemblies and/or other high level radioactive waste from the nuclear reactor.

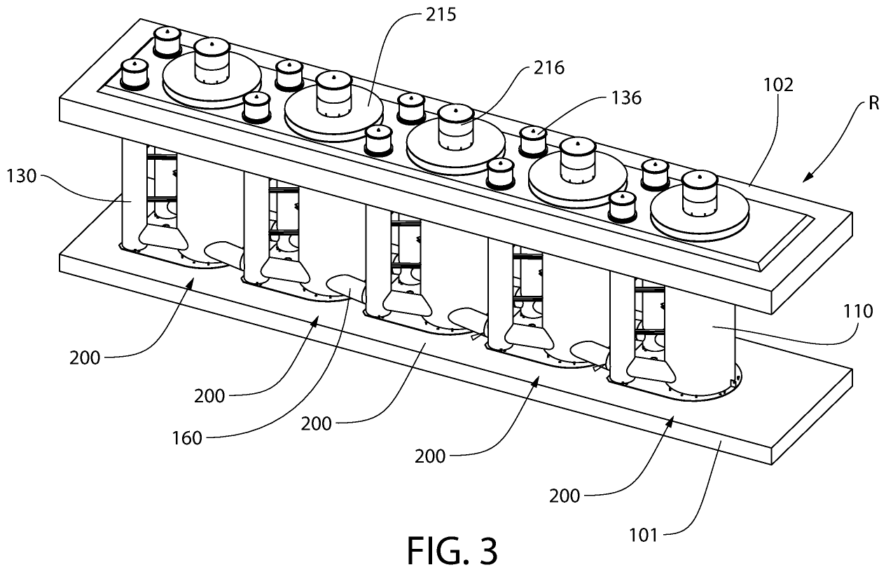

The nuclear waste canister 150 stored in CEC 110 includes a vertically-elongated hollow cylindrical shell 151, top closure plate 152, and bottom closure plate 153. The top and bottom closure plates are hermetically seal welded to the top and bottom ends of shell 151 to form a gas-tight containment boundary for the nuclear waste stored in the canister. Canister 150 (i.e. shell and closure plates) may be formed of stainless steel in preferred embodiments for corrosion resistance. Canister 150 has a height H3 smaller than the height H2 of the CEC shell body 111 such that the top of the canister is spaced vertically apart and downwards from the bottom of the concrete top pad 102 (see, e.g., FIG. 3). This helps to both ensure that there is no lateral radiation streaming outwards from the CEC 110 at the top, and provides impact protection from incident projectiles (e.g., missiles, etc.). Canister 150 may be any type of nuclear waste/SNF canister, including without limitation Multi-Purpose Canisters (MPCs) available from Holtec International of Camden, N.J.

CEC 110 further includes a baseplate 114 hermetically seal welded to the bottom end 113 of shell body 111. A plurality of metallic radial support lugs 124 are welded to baseplate 114 and/or inside surface of the CEC shell body 111 in a circumferentially spaced apart manner at the bottom of cavity 120. The lugs are formed of suitable metal (e.g., stainless steel or other) and act to support and elevate the canister 150 above the baseplate. This creates open space between the top of the baseplate 114 and bottom closure plate 153 of the canister 150 to allow cooling ventilation air to circulate beneath the canister for removing heat emitted from the bottom of the canister by the nuclear waste material stored therein.

In one embodiment, the support lugs 124 may be generally L-shaped having a horizontal portion 124a welded to baseplate 114 and an integral adjoining vertical portion 124b welded to the inner surface of the CEC shell body 111. Vertical portions 124b each define radially-extending lower seismic restraint members which engage the sides of the canister 150 to keep it centered in the cavity 120 of the CEC 110 particularly during a seismic event (e.g., earthquake). A plurality of radially-extending upper seismic restraint members 123b project inwards from the shell body 111 in cavity 120 to keep the upper portion of the canister 150 centered. Restraint members 123b may be formed by circumferentially spaced apart metal plates or lugs welded to the inner surface of the CEC shell body 111.

When the canister 150 is positioned in the cavity 120 of the CEC 110, a ventilation annulus 121 is formed therebetween which extends for the full height of the canister. The ventilation annulus is fluid communication with the cooling air feeder shells 130 at the bottom via flow conduits 160 and an air outlet plenum 152 formed inside the CEC cavity 120 above the canister.

The shell body 111 and baseplate 114 of each CEC 110 may be formed of a suitable metal such as stainless steel for corrosion resistance.

The top end 112 of CEC 110 is enclosed by a removable thick radiation shielded lid 115 detachably mounted on top of the CEC shell body 111. The lid may have a composite metal and concrete construction including an outer shell 115a formed of steel such as stainless steel, and interior concrete lining 115b. This robust construction not only provides radiation shielding, but also offers added protection against projectile impacts. In one configuration, lid 115 includes a cylindrical circular upper portion 116a and adjoining cylindrical circular lower portion 116b having an outer diameter D4 smaller than an outer diameter D3 of the upper portion. An annular stepped shoulder 116c is formed between the upper and lower portions of the lid. Diameters D3 and/or D4 in some embodiments may be larger than an outer diameter D2 of the CEC shell body 111.

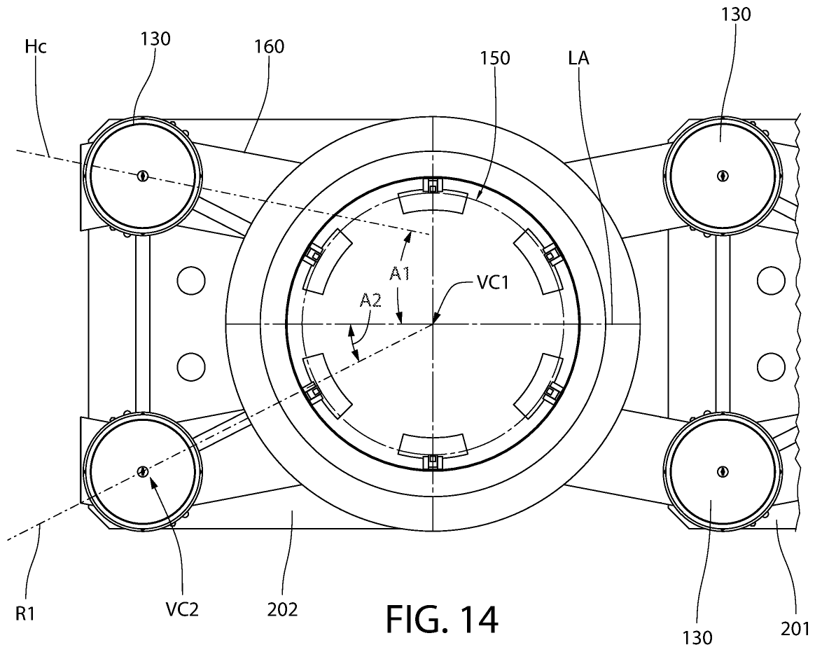

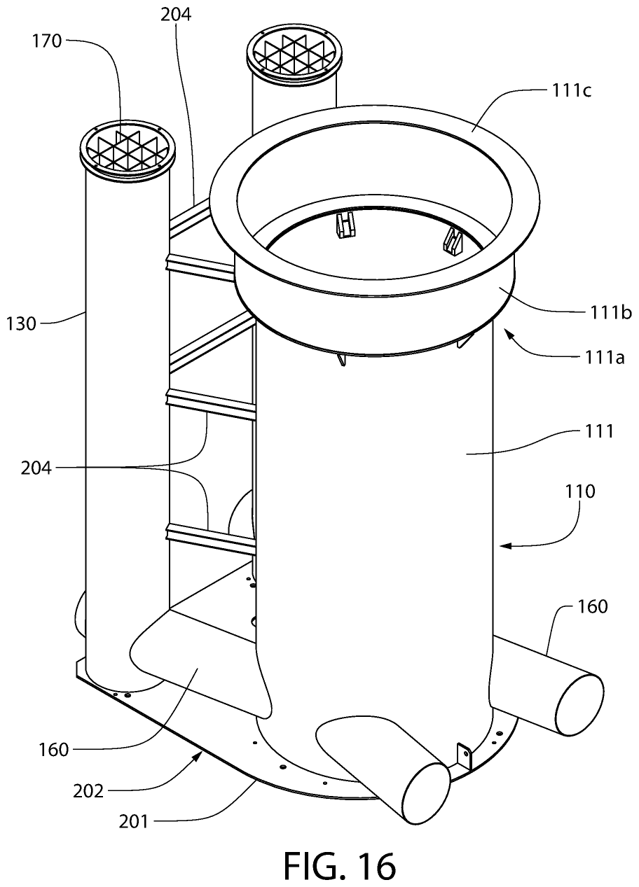

Lower portion of 116b of lid 115 is insertably positioned inside a corresponding upwardly open circular recess 117 formed into the top surface 102a of the top pad 102 around the top end 112 of each CEC 110 as shown (see, e.g., FIGS. 4-5). Recess 117 is larger in diameter D5 that the outer diameter D2 of the CEC shell body 111. In one embodiment, the upper portion 111a of CEC 110 (i.e. shell body 111) may include a diametrically enlarged top cylindrical section 111b which has the same diameter D5 as recess 117 and in fact defines the recess in this embodiment shown in FIGS. 14 and 16). The lid is slightly elevated and ajar from top pad 102 in its recess to create an air outlet 118 thereby forming an exit pathway between the lid and CEC 110 for the rising ventilation air from the cavity 120 of the CEC to return to ambient atmosphere. The air outlet 118 is configured to form a circuitous multi-angled pathway such that there is no direct line of sight from cavity 120 to atmosphere for radiation to escape (i.e. radiation streaming) Outlet 118 may have a double L-shaped configuration in one embodiment for this purpose as shown in FIG. 2; however other circuitous shaped pathways may be used.

In some embodiments as shown in FIGS. 16-18, the top section 111b of the CEC shell body 111 may further include a flat radially projecting annular seating flange 111c. The seating flange is configured for engaging and resting on top surface 102a of the concrete top pad 102.

Each cooling air feeder shell 130 is a tubular hollow structure comprising a metallic vertically-elongated body 131 defining a vertical centerline axis VC2 and bottom closure plate 132 welded to the bottom end 134 of the shell. The vertical centerlines VC2 and VC1 of the CECs 110 are parallel to each other. The body 131 may be cylindrical with a circular transverse cross-sectional shape in preferred non-limiting embodiments; however, other non-polygonal and polygonal shaped bodies may be used in certain other acceptable embodiments. The body 131 of each feeder shell defines an open vertical air passage 133 extending between the bottom end 134 and top end 135 of the shell 130 for drawing ambient cooling air downwards through the shell. The top end of shell 130 may terminate at the top surface 102a of the concrete top pad 102 in some embodiments. A perforated air intake housing 136 is coupled to the top end 135 of the shell 130 which projects vertically upwards from the top pad 102 as shown. In one embodiment, housing 136 may be formed of a cylindrical shell which is perforated to form a plurality of lateral openings extending 360 degrees circumferentially around for drawing air laterally into the feeder shell 130. A circular cap 137 encloses the top of the air inlet housing 136 to prevent the ingress of rain. The air feeder shell 130, bottom closure plate 132, air intake housing 136, and cap 137 may be formed of metal such as stainless steel for corrosion protection. Other shaped caps and intake housings may be used in other embodiments.

To minimize rising air leaving the top of the cavities 120 of the CECs 110 which has been heated by the canisters 150 from being drawn back into the intake housings 136 of the cooling air feeder shells 130, each feeder shell is preferably spaced apart from the shell bodies 101 of adjacent CECs by a sufficient lateral/horizontal distance such as at least one outer diameter D1 of feeder shell in some embodiments.

With continuing reference to FIGS. 4 and 5, cooling air feeder shells 130 have a height H1 which is at least coextensive as height H2 of CEC shell bodies 111. As one non-limiting example, H2 and H1 may be about 227 inches (576.6 cm). In one embodiment, shells 130 may have a slightly greater height H1 (measured between bottom and top ends 134, 135) than height H2 of the CEC shell bodies 111 (measured between bottom and top ends 113, 112 of the bodies in including upper portion 111a).

The canister 150 has a total height H3 (inclusive of the top and bottom closure plates 152, 153) less than height H2 of the CEC shell bodies 111 so that an air outlet plenum 154 is formed between the bottom of CEC lid 115 and the top closure plate 152 of the canister. The top of the canister defined by top closure plate 152 terminates beneath the concrete top pad 102 of the CIS system at an elevation that may fall within the vertical extent of the engineered fill 140. This helps prevent “sky shine” radiation streaming to the ambient environment.

Referring to FIGS. 1 and 2, the cavity enclosure containers 110 and cooling air feeder shells 130 in one embodiment may be arranged in a tightly packed array to minimize spatial site requirements at the CIS facility. The array comprises a plurality of longitudinally-extending and parallel linear nuclear waste storage rows R each including a plurality of CECs 110 and cooling air feeder shells 130. For convenience of illustration, the array in FIGS. 1-2 shows only five rows R; however, it is recognized that more or less rows of CECs and air feeder shells may of course be provided as needed. Each row defines a respective horizontally-extending longitudinal axis LA. The geometric centers of each CEC which intersect their vertical centerline axes VC1 intersect the respective longitudinal axis LA in each row such that the CECs 110 may be considered to be located on the longitudinal axis. For convenience of reference, a transverse axis TA may be defined as oriented perpendicularly to the longitudinal axis LA in each row extending front to back between rows R in the array (see, e.g., FIG. 2).

The nuclear waste storage rows R of CECs 110 are spaced apart and parallel to each other to form longitudinally-extending access aisles AI which provide access for commercially-available motorized wheeled or track driven lifting equipment such as without limitation cask crawlers or other equipment which transport, maneuver, and raise/lower the canisters 150 for insertion into and removal from the CECs 110. The equipment may straddle the row of CECs 110 and the wheels or tracks run in aisles AI on each side of the row. Such equipment is well known to those skilled in the art without further elaboration. The low exposed vertical profile of the CECs 110 (as further described herein) allows the equipment to move over the CECs modules in a single row to the desired CEC for inserting or removing canisters.

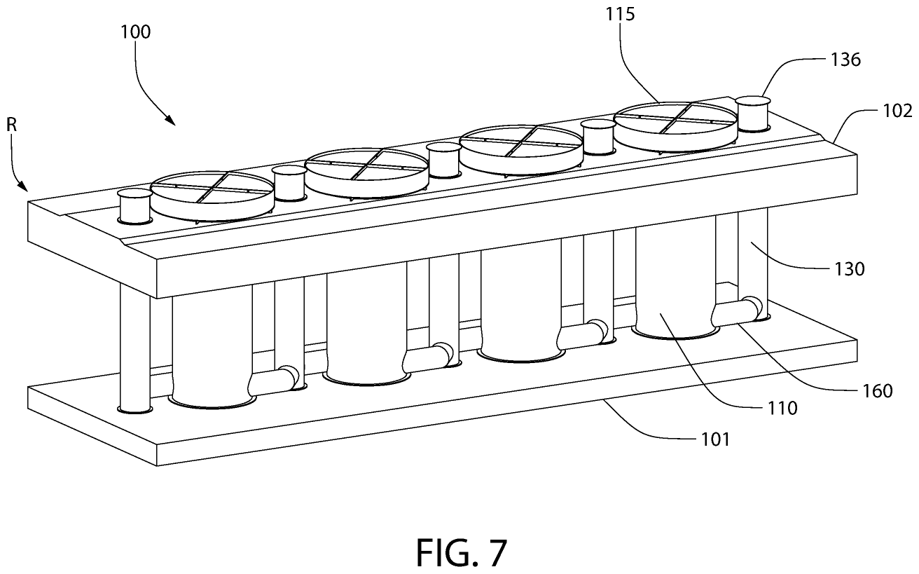

FIGS. 4-7 show a possible first embodiment and arrangement of CECs 110 and cooling air feeder shells 130. In this embodiment, each CEC 110 in each row R is fluidly coupled directly to a pair of cooling air feeder shells 130 by horizontally/laterally extending flow conduits 160; one each of feeder shells 130 being on opposite lateral sides of the CECs along the longitudinal axis LA as shown. Viewed the other way, each air feeder shell 130 may be considered centrally located between a pair of CECs. Each CEC therefore comprises a pair of air inlets 125 on opposite sides forming openings which extend through the shell body 111 of the CEC 110 to the internal cavity 120. The air inlets 125 are therefore formed in and through the lower portion 111d of the CECs (i.e. shell body 111) to introduce cooling air into the bottom of the CEC cavity 120 and ventilation annulus 121. In a preferred but non-limiting embodiment, the air inlets 125 are each configured and arranged to introduce cooling ventilation air tangentially into the cavity 120 of each CEC 110 as shown. Introduction of cooling air in this tangential manner which flows circumferentially around the inner surface of the CEC to quickly fill the CEC cavity and ventilation advantageously results in less pressure drop than introducing the air radially and perpendicularly at the canister shell 151.

The flow conduits 160 comprise sections of horizontally-extending metal piping spanning between the cooling air feeder shells 130 and their respective CECs 110. The flow conduits fluidly couple each CEC air inlet 125 “directly” to a respective air feeder shell 130 meaning that the cooling air passes from the feeder shell to the respective CEC without passing through any other CEC or feeder shell on the way. As previously described herein, this arrangement advantageously maximizes the amount of cooing air received by each CEC 110 commensurate with the level of heat emitted by the canisters in each CEC which may differ. Accordingly, no CEC is starved of its required cooling air flow by any upstream CEC. Because the CECs and their nuclear waste material contents are passively and convectively cooled via the natural thermo-siphon effect as previously described herein, pressure imbalances in the cooling air ventilation system which can adversely affect proper cooling of each CEC are avoided by the present cooling equipment arrangement. The provision of two air inlets 125 for each CEC 110 and separate sources of cooling air (i.e. feeder shells 130) for each inlet further ensures each CEC is cooled to remove the heat generated in its cavity to the maximum extent possible.

For the same foregoing reasons to ensure each CEC 110 receives the needed amount of cooling air based on its particular heat load generated by the nuclear waste canister 150 therein, it further bears noting that there is no interconnecting flow conduits between any CECs or cooling air feeder shells 130 in one row and any other rows R. Accordingly, each nuclear waste storage row R is fluidly isolated from every other row.

Although perhaps not readily apparent from the figures, it also bears noting that each CEC 110 in a single row R is fluidly isolated from adjacent CECs and every other CEC in the same row when the ambient air cooling ventilation system is in operation (i.e. nuclear waste canisters 150 disposed in the CECs thereby creating active air flow through the ventilation system via the thermo-siphon effect previously described herein). For example, referring to FIG. 4, ambient cooling air will be drawn downwards in the centrally located air feeder shell 130 and then flow laterally outwards to each of the two CECs 110 pictured via flow conduits 160 (see directional air flow arrows). The cool air enters the bottoms of the CECs and flows vertically upwards as the air in the CEC cavities 120 is heated by the canisters 150 (see, e.g., FIG. 2). Accordingly, given the direction of flow through these nuclear waste storage system components, air cannot possibly flow from one CEC 110 backwards through the centrally located air feeder shell 130 and into the remaining CEC. The CECs are therefore effectively fluidly isolated from each other.

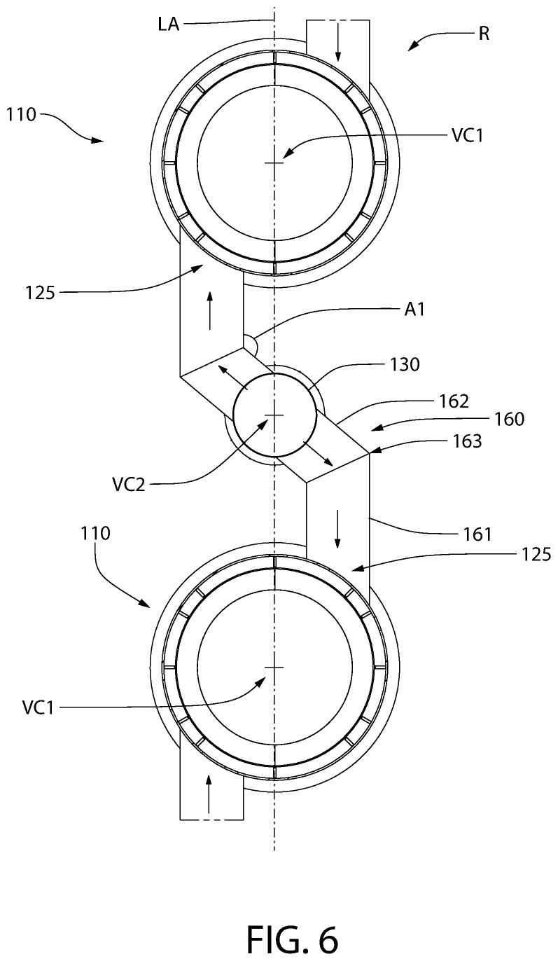

As previously noted, the flow conduits 160 may comprise sections of metal piping such as stainless steel of suitable diameter. In preferred but non-limiting embodiments, the flow conduits are configured such that there is no straight line of sight between each cooling air feeder shell 130 and either of its respective pair of cavity enclosure containers 110 fluidly coupled thereto to prevent radiation streaming. This concomitantly also ensures there is no straight line of sight between any of the CECs 110 in the row R through the feeder shells 130. In one configuration, flow conduits 160 may each comprise an angled transverse section 162 oriented transversely to the longitudinal axis LA, and an adjoining longitudinal section 161 oriented parallel to the longitudinal axis. A welded mitered joint 163 may be formed between the transverse and longitudinal sections (see, e.g., FIG. 6). An oblique angle is formed between these two sections of the flow conduit. In other possible embodiments, curved piping elbows may be used instead of mitered sections of straight piping to prevent the straight line of sight.

Because each cooling air feeder shell 130 need only be sized in diameter to supply cooling air to a pair of CECs 110, the diameter of the feeder shells can be minimized to allow CECs in each row to be closely spaced. This advantageously allows more CECs and nuclear waste to be packed into each row R. Accordingly, in preferred but non-limiting embodiments, the outer diameter D1 of the feeder shells 130 may be smaller than the outer diameter D2 of the CECs 110. As one non-limiting example, D1 may be about 30 inches (76.2 cm) and D2 may be about 84 inches (213.4 cm). For size comparison, the flow conduits 60 may have a smaller diameter than D1 or D2; such as for example without limitation about 24 inches (61 cm) in one embodiment. Other diametrical sizes may be used in other embodiments and does not limit the invention.

To summarize operation of the nuclear waste storage system and ambient cooling air ventilation system, nuclear waste canisters 150 containing radioactive waste materials (e.g. SNF fuel assembly and/or other high level radioactive waste materials removed from the reactor) are loaded into the CECs 110. The lids 115 are then placed onto the CECs to enclose the CECs and their internal cavities.

With the canisters positioned inside the CECs and lids in place, air in the ventilation annulus 121 between the canister and shell body 111 of each CEC 110 becomes heated by the canister. The heated air rises, collects in the air outlet plenum 154 above the canister in cavity 120 of the CEC, and exits the CEC back to atmosphere through the air outlet 118 formed through the lid 115 of the CEC (see directional air flow arrows in FIGS. 4-5 and 18).

The upward convective flow of air inside cavity 120 of each CEC 110 creates a negative pressure which draws ambient air down into the cooling air feeder shell 130 via the known thermo-siphon effect or mechanism. The CEC draws the air from the bottom of the air feeder shell into the lower portion of its internal cavity 120 and ventilation annulus 121 through the flow conduits 160 to complete the ventilation air flow circuit. It bears noting that this natural air flow is unassisted by powered fans or blowers, thereby avoiding operating costs associated with electric power consumption, but importantly ensuring continued cooling of the CECs 110 in the event of power disruption to prevent overheating the CECs and protect the containment of the nuclear waste materials.

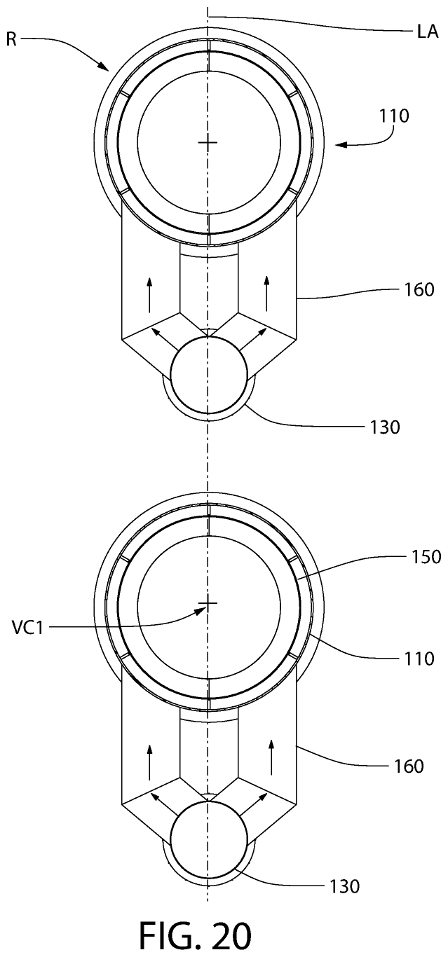

FIG. 20 depicts an alternative second embodiment and arrangement of a nuclear waste storage system and corresponding air ventilation system. In this embodiment, each CEC 110 is fluidly coupled to only a single cooling air feeder shell 130 by a pair of angled/curved flow conduits 160 to prevent radiation streaming as previously described herein. The CEC includes two air inlets 125 also arranged to introduce ventilation air tangentially into the internal cavity of the CEC. The bifurcated ventilation air supply effectively creates a curtain of cooling air around the nuclear waste canister 150 inside the CEC with minimal flow resistance to maximize the air flow for cooling the radioactive waste material. This alternative embodiment may be appropriate where certain canisters 150 are still emitting extremely high levels of thermal energy (heat) which must be dissipated in order to protect the structural integrity of the canister and nuclear waste therein. Multiple pairs of the fluidly isolated CECs 110 and cooling air feeder shells 130 in FIG. 20 may be arranged in a row R of the CIS facility. The CECs 110 and air feeder shells 130 are arranged on the longitudinal axis LA of each row R that may be provided in the array of CECs.

It bears noting that certain CIS facilities may combine some rows of CECs 110 and air feeder shells 130 according to the arrangement shown in FIG. 20 for high thermal energy emitting nuclear waste canisters, and some other rows of CECs and air feeder shells according to the arrangement shown in FIGS. 4-7 for lower thermal energy emitting nuclear waste canisters. In yet other embodiments, the two different arrangements of CECs and air feeder shells may be mixed in a single row R. Accordingly, numerous variations are possible depending on particular nuclear waste material storage needs and level of thermal energy emitted by the canisters 150.

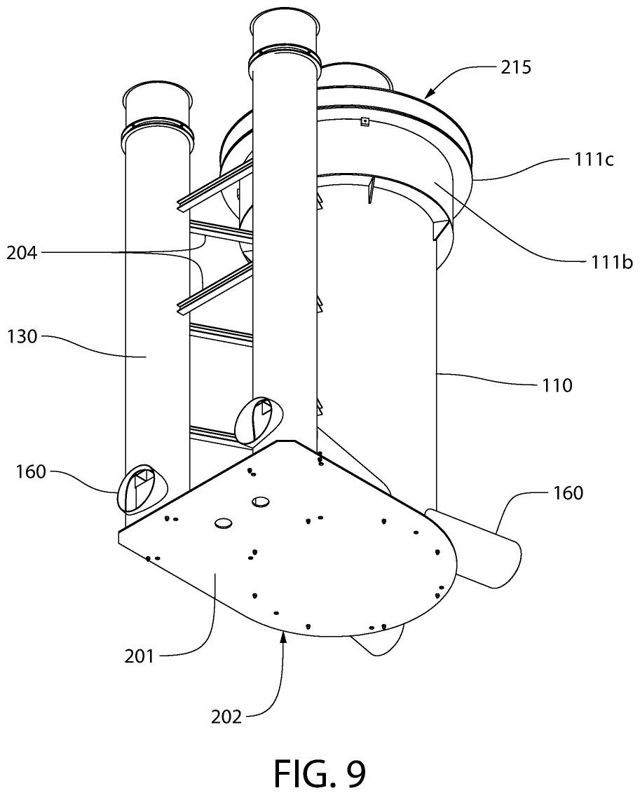

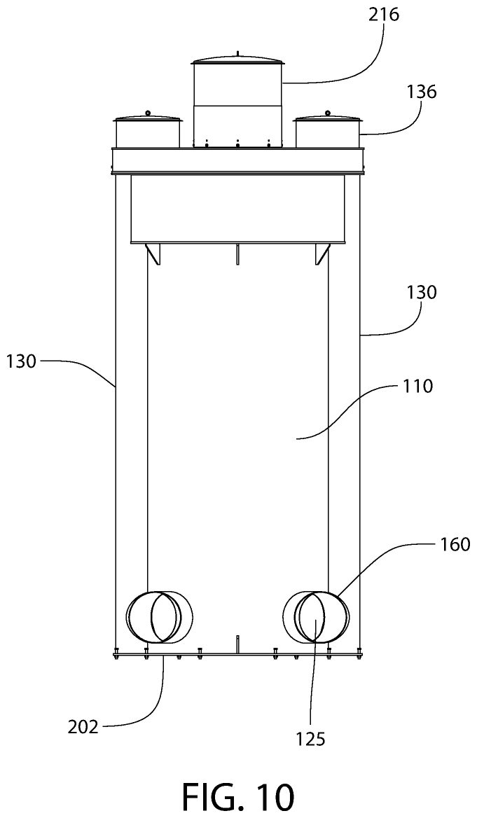

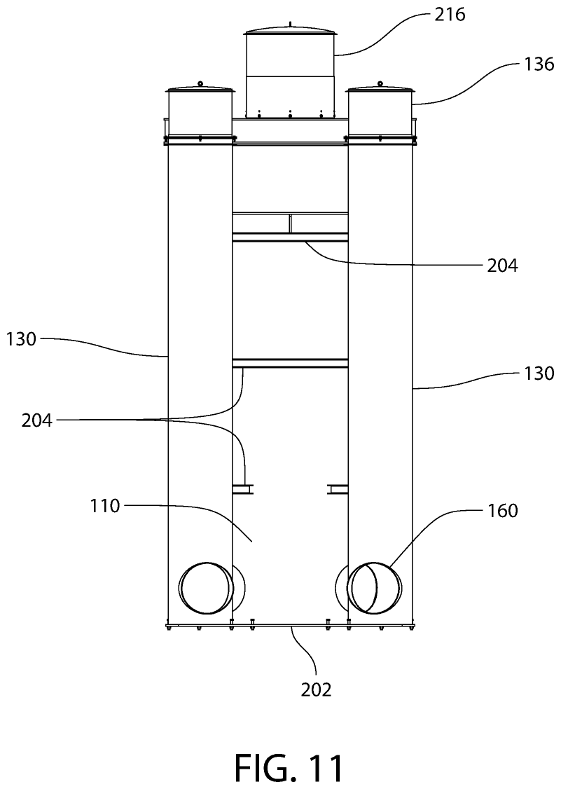

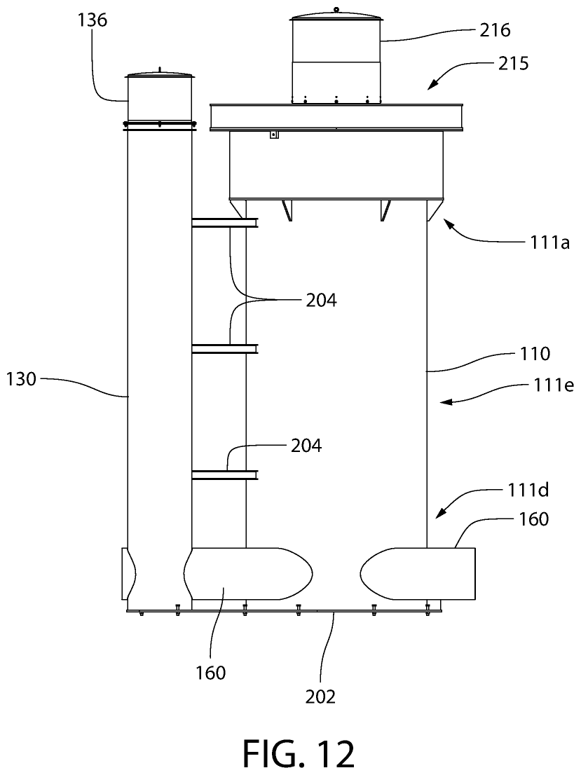

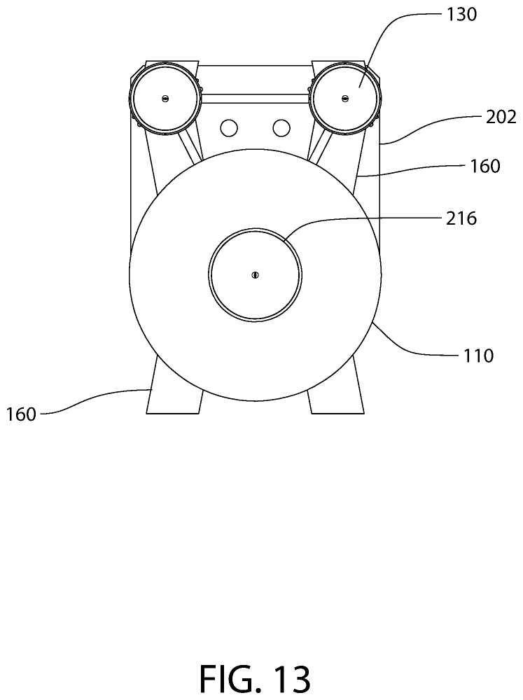

FIGS. 1-3 and 8-19 depict yet another third alternative embodiment and arrangement of a nuclear waste storage system and corresponding air ventilation system. This a high airflow capacity configuration of the passively cooled nuclear waste storage system with thermo-siphon driven ventilation system suitable for radioactive nuclear waste emitting extremely high levels of heat that must be dissipated by ambient cooling air to protect the radioactive waste (e.g. SNF fuel assemblies, etc.) inside the nuclear waste canisters 150. The cooling air requirements of these high heat load CECs may exceed even the higher airflow capacity provided by the CECs in FIG. 20 with a dedicated separate pair of cooling air feeder shells 130 as shown.

Accordingly, CECs 110 in this high airflow capacity third embodiment may each be fluidly coupled to two pairs (i.e. four) cooling air feeder shells 130 by air flow conduits 160 (see, e.g., FIGS. 1-3 and 14). With continuing reference to FIGS. 1-3 and 8-19 generally, one pair of feeder shells 130 may be located on one lateral side of the CEC, and the remaining pair of feeder shells may be located on the opposite other lateral side as shown. The CEC includes four air inlets 125; each of which is fluidly coupled by a flow conduit 160 to one of the four cooling air feeder shells 130. The flow conduits 160 may be similarly configured and arranged to the prior embodiments of the ambient air ventilation system previously described herein to introduce ventilation air tangentially into the lower/bottom portion of internal cavity 120 of the CEC 110 in order to achieve the same airflow benefits noted above.

It bears noting that each CEC 110 in a single row R need not necessarily be coupled to four cooling air feeder shells 130 as seen in FIGS. 1-3. For example, one CEC 110 located at one end of row R is shown fluidly coupled to only a pair of cooling air feeder shells 130 as this CEC may not have a heat load as high as the heat loads of the remaining other CECs in the depicted row which require a higher ambient ventilation air flow volume or rate (e.g. CFM—cubic feet per minute) to dissipate the higher heat emissions from the canisters 150 stored therein. Accordingly, the present passively cooled nuclear waste storage and ventilation system offers considerable flexibility in configuration which can be customized in order to accommodate the particular heat load dissipation needs of the CECs which may differ.

With continuing general reference to FIGS. 1-3 and 8-19, the construction and structural details of the CECs 110 in this third embodiment and arrangement of passively-cooled nuclear waste storage system may be similar to the previously described embodiments with exception of the additional cooling air inlets 125 to accommodate the two pairs of cooling air feeder shells 130. The description of the CEC structure including lid 115 will therefore not be repeated here for sake of brevity. The features or parts of the CEC in the presently illustrated third embodiment of the nuclear waste storage system are therefore numbered the same as in the figures for the first and second embodiments.

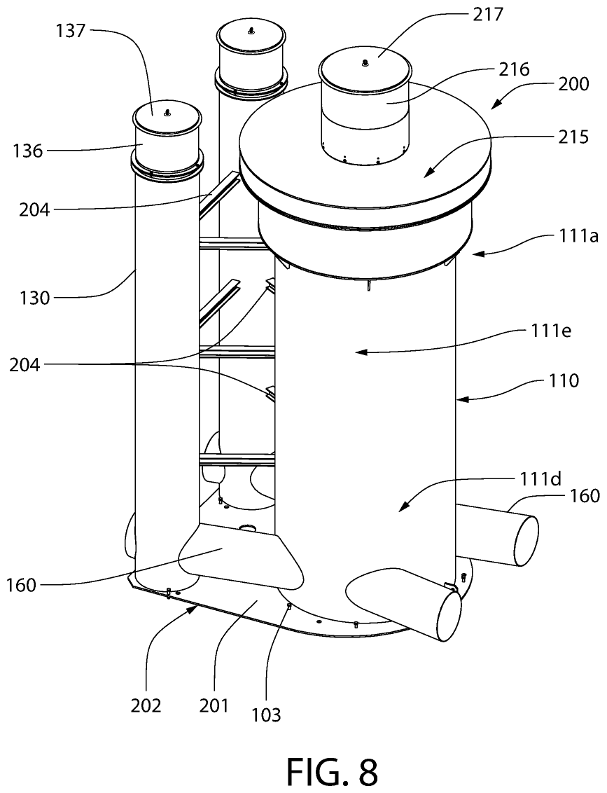

In the present high air flow embodiment shown in FIGS. 1-3 and 8-19, the CECs 110 and cooling air feeder shells 130 however have been structurally integrated into a readily transportable and mountable modular nuclear waste storage unit 200 (best seen in FIGS. 8-16). The modular unit 200 is a self-supported and transportable assemblage or structure which includes a common or shared support plate 202 formed of a suitably strong and appropriate metallic material (e.g., stainless steel or other). The support plate 202 has a horizontally broadened and flat body 201 configured for mounting and anchoring onto the top surface of the subterranean concrete base pad 101 such as via anchors 103 which may be threaded fasteners or other type anchoring/mounting devices. One CEC 110 and a single pair of cooling air feeder shells 130 on one lateral side of the CEC are fixedly attached to the common or shared support plate 202 such as via welding. The support plate 202 may have any suitable configuration, such as a U-shaped mixed polygonal-non-polygonal configuration in one non-limiting embodiment as shown.

To ensure that the vertically tall shell body 111 of the CEC 110 and pair of cooling air feeder shells 130 are structurally stabilized and braced for lifting and transport as a single self-supporting unit, a plurality of horizontally-extending cross-support members 204 (e.g., structural beams of suitable shape) are provided which structurally ties the CEC shell body and feeder shells together in a rigid manner. In one embodiment (as variously appearing in FIGS. 8-16), the CEC 110 in each modular nuclear waste storage unit 200 is structurally tied and laterally braced to each of the pair of cooling air feeder shells 130 by a plurality of vertically spaced apart cross-support members 204. In the non-limiting illustrated embodiment, three cross-support members are shown to tie each of the lower portion 111d, middle portion 111e, and upper portion 111a of the CEC to each of the two feeder shells 130. More or less cross-support members 204 may be used. The pair of cooling air feeder shells 130 are similarly structurally tied together and laterally braced by vertically spaced apart cross-support members 204 which may be of the same type or different than the cross-support structural members tying the CEC 110 to each of the cooling air feeder shells 130. In one non-limiting embodiment, a W-beam may be used for cross-support structural members 204; however, other suitable type/shape structural members may be used.

The modular nuclear waste storage unit 200 advantageously allows the units to be fabricated under controlled shop conditions in the fabrication facility, and then shipped to the installation site (e.g., Consolidated Interim Storage facility). Since the CEC 110 and pair of cooling air feeder shells 130 are already palletized so to speak on the common support plate 201, installation requires only making the piping connections with the flow conduits 160 at the installation site. This results in rapid installation and deployment of the modular nuclear waste storage units.

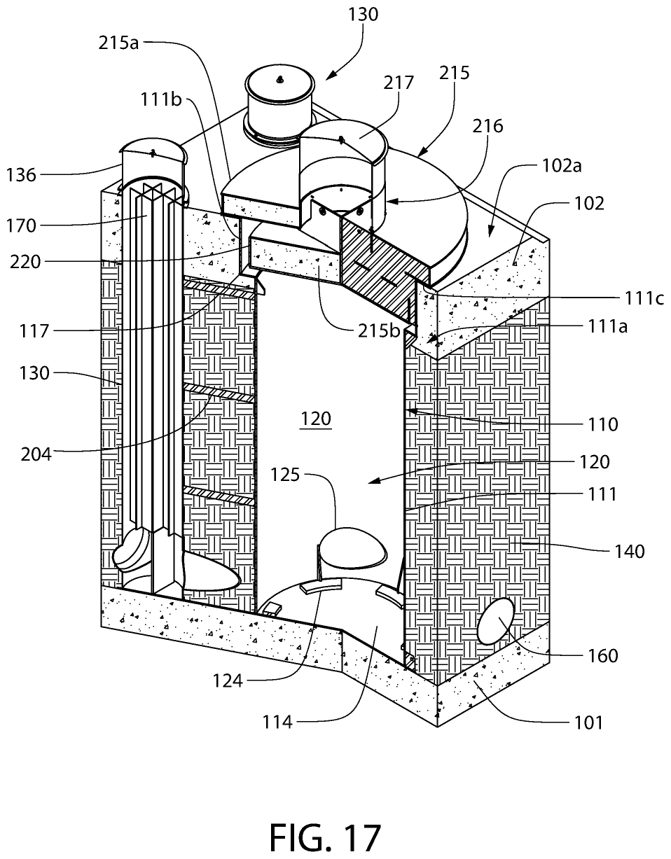

To install the modular nuclear waste storage units 200 in the manner shown in FIG. 3 such as at a CIS site or facility, the installation process or method includes pouring the concrete base pad 101 and then positioning and mounting a first storage unit 200 on the pad when cured and hardened. A second storage unit 200 is next positioned and mounted on the base pad adjacent to the first storage unit in a longitudinally spaced apart manner along the row R. The piping connections can now be made for the first storage unit. Each of the four cooling air feeder shells 130 are then fluidly coupled directly to the CEC 110 of the first storage unit by a separate flow conduit 160. The piping connections between the CEC and feeder shells 160 may be welded or preferably bolted piping flange type connections which can be made more expediently than welded connections. Since the air flowing inside the flow conduits 160 is at most at air a slight negative (sub-atmospheric) pressure when the ventilation system is in operation, flanged type connections are suitable for these service conditions. The next additional third, fourth, so on nuclear waste storage units 200 may then be added and installed in a similar manner. Once all units have been mounted to the base pad 101 and fluidly coupled to their respective cooling air feeder shells 130, the flowable engineered fill 140 may be installed on top of the base pad and around the CECs and feeders shells of the CIS facility to fill the voids between this equipment for lateral support and radiation attenuation/blocking as shown in FIGS. 17-19 (note engineered fill not shown in FIG. 3 for clarity).

Next, the concrete top pad 102 may be formed on top of the engineered fill. The modular nuclear waste storage units 200 are now ready for receiving a nuclear waste canister 150 in each cavity 120. In some embodiments as disclosed in U.S. Pat. No. 9,852,822 which is incorporated herein by reference, a pair of canisters 150 may be vertically stacked in each CEC 110 and supported therein in the manner described. It bears noting that the CEC 110 whether holding a single or two vertically stacked canisters 150 has a cross-sectional area sufficient for holding only a single canister at a single elevation (i.e. no side-by-side canister placement).

It bears noting that in the preferred but non-limiting embodiment, the foregoing CECs 110 of the multiple modular nuclear waste storage units 200 are preferably positioned on the longitudinal axis LA of the storage row R (i.e. vertical centerline axis VC1 intersects longitudinal axis LA). This is similar to the previous two embodiments of the nuclear waste storage system 100 shown in FIGS. 4-7 and 20 described above. In the present embodiment shown in FIGS. 1-3, the first and second cooling air feeder shells 130 of the first pair of feeder shells may be transversely spaced apart perpendicularly to and on opposite sides of longitudinal axis LA). The first and second feeder shells are located on a first lateral side of a first CEC 110. The third and fourth cooling air feeder shells of the second pair of feeder shells may similarly be transversely spaced apart in the same manner and located on a second lateral side of the first CEC 110 opposite the first lateral side.

The first, second, third, and fourth cooling air feeder shells 130 are preferably fluidly coupled directly to the first CECs by separate metallic flow conduits 160 as shown in FIG. 3 (see also variously FIGS. 8-19). Accordingly, there are no intervening CECs or cooling air shells. Flow conduits 160 may be formed by sections of piping as previously described herein.

In the present third embodiment, the flow conduits 160 may each comprise a horizontally-extending straight piping section fluidly coupling a lower portion of the cavity 120 of the first CEC 110 to a lower portion of each of the cooling air feeder shells 130. Each straight piping section flow conduit 160 defines a horizontal centerline axis Hc which is acutely angled to longitudinal axis LA by angle A1 (see, e.g., FIG. 14). This angled arrangement of the cooling air feeder shells 130 to the longitudinal axis is sufficient to ensure there is no straight line of sight between the first CEC 110 and the next adjacent CEC which is mounted on a different support plate 201. In certain embodiments, angle A1 may be between about and including 10 to 20 degrees.

As also shown in FIG. 14, the cooling air feeder shells 130 in each pair on opposite lateral sides of the depicted CEC 110 are on opposite sides of longitudinal axis LA. The geometric vertical centerline VC2 of each of the feeder shells falls on a horizontal reference line R1 which is oriented at an acute angle A2 to the longitudinal axis LA of the nuclear waste storage row R. Angle A2 may be about 30 degrees (+/−5 degrees) in one embodiment as illustrated. It bears noting that the angular arrangement of the flow conduits 160 and cooling air feeder shells 130 to the longitudinal axis LA by angles A1 and A2 respectively advantageously contributes to allow closer spacing between the CECs 110 and feeder shells in each row. This allows more CECs to be tightly packed into each row R.

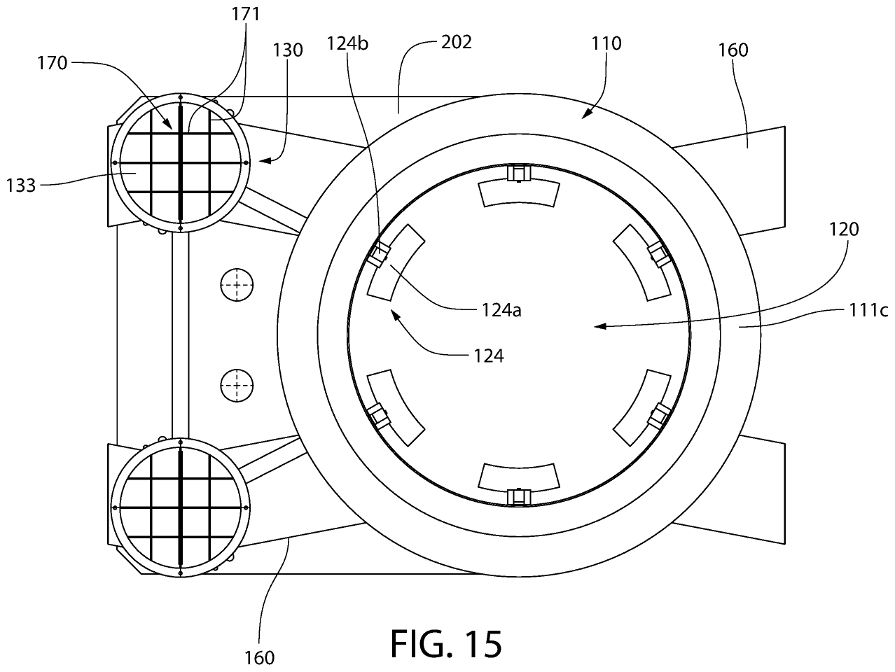

Referring to FIGS. 15-19, each cooling air feeder shell 130 in some embodiments may include an array 170 of vertically elongated radiation attenuator plates 171. The plates 171 may be flat, and are structurally coupled together (e.g. welded, via clips/brackets, etc.) and arranged in an orthogonal grid as shown. Plates 171 are disposed in the vertical air passage 133 of the cooling air feeder shells 130 and create vertically-extending grid openings between them through which the ventilation air is drawn downwards through the shells. Attenuator plates 171 may extend vertically for a majority of the H1 the cooling air feeder shells. In one embodiment, the attenuator plates extend vertically from top end 135 of the shells downwards towards bottom end 134 and terminate at a point just above and proximate to the top of the flow conduits 160 so as to not interfere with the ventilation air flow from the shells 130 to the CECs 110. In one embodiment, attenuator plates 171 may be formed of steel; however, other suitable materials including boron-containing materials and metals may be used. The attenuator plates 171 advantageously help prevent radiation streaming to the ambient environment surrounding the nuclear waste storage system.

In operation, the ambient cooling air ventilation system of the present high airflow capacity embodiment shown in FIGS. 1-3 and 8-19 functions and follows the same general path as the previously described embodiments. The air inlets 125 are each configured and arranged to introduce cooling ventilation air tangentially into the cavity 120 of each CEC 110 as shown. Ambient ventilation air is drawn downwards through and between the attenuator plates 171 inside each cooling air feeder shell 130, and then flows horizontal/laterally to the CEC 110 through flow conduits 160 to cool the canister 150 in each CEC via the convective natural thermo-siphon effect previously described herein.

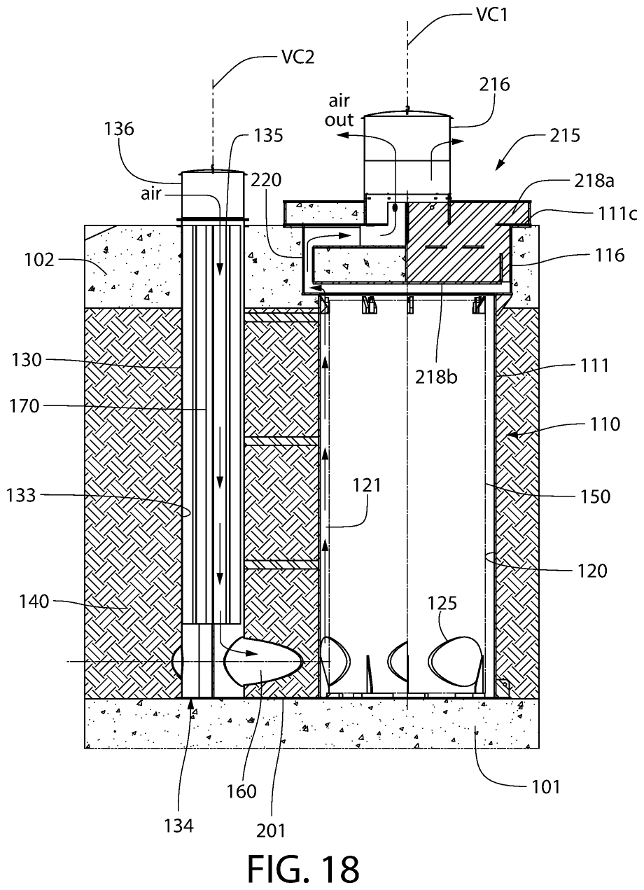

In the present embodiment of FIGS. 1-3 and 8-19, an alternative air outlet 220 is shown which is formed directly through lid 215 rather than between the periphery of the lid and upper portion 111a of the CEC 110 and top pad 102 as with previous lid 115 in prior embodiments of FIGS. 4-7 described herein. In the present embodiment, the air outlet 220 forms a circuitous multi-angled passageway internally through the lid terminating in air discharge housing 216 mounted to the top surface of the lid (see, e.g., FIG. 18 and directional airflow arrows). To accommodate this internal air outlet 220 passage, lid 215 is configured slightly differently than lid 115 previously described herein.

Air discharge housing 216 of present lid 215 comprises a perforated cylindrical metal shell which projects vertically upwards from the top surface of the lid 215 as shown. In one embodiment, housing 216 comprises a plurality of lateral openings extending 360 degrees circumferentially around for discharging air laterally outwards therefrom back to the ambient environment. A circular cap 217 encloses the top of the air discharge housing 216 to prevent the ingress of rain. The air discharge housing 216 and to cap 217 may be formed of metal such as stainless steel for corrosion protection. Other shaped caps and intake housings may be used in other embodiments.

The present lid 215 may have a composite metal and concrete construction and shape similar to previous lid 115 in FIGS. 4-7 including an outer shell 215a formed of steel such as stainless steel, and interior concrete lining 215b. This robust construction not only provides radiation shielding, but also offers protection against projectile impacts. In one configuration, lid 215 includes a circular upper portion 218a and adjoining circular lower portion 218b having an outer diameter smaller than an outer diameter of the upper portion similar to previous lid 115. The present lid 215 effectively seals off the upwardly open recess 117 formed into the top surface 102a of the top pad 102 around the top end 112 of each CEC 110 by the upper diametrically enlarged top cylindrical section 111b of the CEC.

In cooling operation, air rising upwards within ventilation annulus 121 between the heat-emitting canister 150 and shell body 111 of CEC 110 flows to the bottom of lid 215 (see, e.g., FIG. 18 and directional airflow arrows). The air then flows radially outwards and then turns upwards around the periphery of the smaller diameter lower portion 218b of the lid within air outlet 220. The air then flows radially inwards and turns 90 degrees upwards towards the discharge housing 216. The heated air is discharged laterally and radially from housing 216 through the perforations back to ambient atmosphere. The cooling cycle operates continuations via the thermo-siphon as long as the nuclear waste canister 150 continues to emit heat generated by the nuclear waste inside.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. An underground passively ventilated nuclear waste storage system comprising:
a horizontal longitudinal axis;
a subterranean concrete base pad;
a vertically elongated first cavity enclosure container located on the base pad and the longitudinal axis, the cavity enclosure container defining a vertical centerline axis and comprising a first air inlet, a second air inlet, an air outlet, and an internal cavity;
the cavity of the first cavity enclosure container being configured for holding a nuclear waste canister which contains radioactive nuclear waste emitting heat;
a vertically elongated first cooling air feeder shell in fluid communication with an ambient atmosphere and operable to draw in ambient air, the first cooling air feeder shell being fluidly coupled directly to the first air inlet of the first cavity enclosure container via a first flow conduit;
a vertically elongated second cooling air feeder shell in fluid communication with the ambient atmosphere and operable to draw in ambient air, the second cooling air feeder shell being fluidly coupled directly to the second air inlet of the first cavity enclosure container via a second flow conduit.

2. The system according to claim 1, wherein the first cavity enclosure container is not fluidly coupled directly to any other cavity enclosure container.

3. The system according to claim 2, wherein the first cavity enclosure container is structurally coupled to each of the first and second cooling air feeder shells by a plurality of horizontally-extending cross-support members which act as lateral bracing.

4. The system according to claim 3, wherein the first and second cooling air feeder shells are structurally coupled together by a plurality of horizontally-extending cross-support members which act as lateral bracing.

5. The system according to claim 1, wherein the first cavity enclosure container and the first and second cooling air feeder shells are fixedly mounted on a common support plate forming a self-supporting and transportable modular unit, the common support plate being configured for anchoring onto the concrete base pad.

6. The system according to claim 1, wherein the first and second flow conduits each comprise a horizontally-extending straight piping section fluidly coupling a lower portion of the cavity of the first cavity enclosure container to a lower portion of each of the first and second cooling air feeder shells.

7. The system according to claim 6, wherein the first and second flow conduits are oriented at an acute angle to the longitudinal axis.

8. The system according to claim 7, wherein the first and second air inlets of the first and second cavity enclosure containers are configured to introduce the cooling air tangentially into the internal cavity of the first and second cavity enclosure containers, respectively.

9. The system according to claim 1, wherein the first and second cooling air feeder shells are spaced apart and located on a first lateral side of the first cavity enclosure container.

10. The system according to claim 9, further comprising third and fourth cooling air feeder shells spaced apart and located on a second lateral side of the first cavity enclosure container opposite the first lateral side, the third and fourth cooling air feeder shells each being fluidly coupled directly to the first cavity enclosure container by third and fourth flow conduits, respectively.

11. The system according to claim 10, wherein the third and fourth cooling air feeder shells are fluidly coupled directly to a second cavity enclosure container by fifth and sixth flow conduits, respectively.

12. The system according to claim 11, wherein second cavity enclosure container is located on the longitudinal axis, and the first, second, third, and fourth cooling air feeder shells are not located on the longitudinal axis.

13. The system according to claim 12, wherein the first and third cooling air feeder shells are located on a first side of the longitudinal axis, and the second and fourth cooling air feeder shells are located on a second side of the longitudinal axis opposite the first side of the longitudinal axis.

14. The system according to claim 1, wherein the first and second cooling air feeder shells each comprise a vertical air passage containing a plurality of orthogonally intersecting radiation attenuator plates arranged in grid extending vertically for a majority of a height of the first and second cooling air feeder shells.

15. The system according to claim 1, further comprising a concrete top pad defining a top surface, the top pad being spaced apart from and arranged parallel to the base pad, and an engineered fill disposed between the top and base pads.

16. The system according to claim 15, wherein each of the first and second cavity enclosure containers comprises an upper portion embedded in the top pad, and a removable top lid which covers the internal cavity of the first cavity enclosure container.

17. The system according to claim 16, wherein the air outlet of the first cavity enclosure container is formed by an air flow exit pathway extending between the top lid and the internal cavity of the first cavity enclosure container.

18. The system according to claim 16, wherein the top lid is partially disposed in an upwardly open recess formed in the top pad.

19. The system according to any one of claim 15, wherein the first cavity enclosure container comprises a body having a height extending upwards from the base pad into the top pad, and the first and second cooling air feeder shells each have a height extending upwards from the base pad to a top surface of the top pad.

20. The system according to claim 19, wherein the height of the first and second cooling air feeder shells are each at least coextensive with the height of the body of the first cavity enclosure container.

21. The system according to claim 20, wherein the first and second cooling air feeder shells each include a perforated air intake housing disposed above the top surface of the top pad.

22. The system according to claim 1, wherein the first and second cooling air feeder shells and the first cavity enclosure container are cylindrical, the first and second cooling air feeder shells each having an outer diameter smaller than a outer diameter of the first cavity enclosure container.

23. The system according to claim 1, wherein a cooling air flow pathway is defined and configured in which ambient cooling air is drawn vertically down into the first and second cooling air feeder shells, flows horizontal through the first and second flow conduits to the first cavity enclosure container respectively, rises vertically in the cavity of the first cavity enclosure container, and exits laterally from the air outlet in the first and second cavity enclosure container back to atmosphere.

24. The system according to claim 23, wherein cooling air flow is driven by a natural convective thermo-siphon effect unassisted by blowers or fans.

25. The system according to claim 1, wherein the first and second cooling air feeder shells and the first cavity enclosure container are formed of stainless steel.

26-65. (canceled)
